(19) United States
(12) Patent Application Publication
(10) Pub. No.: US 2014/0343960 A1
(43) Pub. Date: Nov. 20, 2014

(54) SYSTEM AND METHOD FOR AUTOMATIC PROCESSING OF PATIENT RESPONSIBILITY PAYMENTS

(71) Applicant: First Data Corporation, Greenwood Village, CO (US)

(72) Inventors: Joan Christensen, Omaha, NE (US); Leeann Humble, Omaha, NE (US)

(73) Assignee: First Data Corporation, Greenwood Village, CO (US)

(21) Appl. No.: 14/280,472

(22) Filed: May 16, 2014

Related U.S. Application Data
(60) Provisional application No. 61/823,968, filed on May 16, 2013.

(51) Int. Cl. G06Q 20/10; G06Q 50/22

(52) U.S. Cl. CPC G06Q 20/102; G06Q 50/22; G06Q 40/08
USPC 705/2

(57) ABSTRACT

Secondary medical claims for medical charges to a consumer not paid by primary insurance are automatically submitted and paid, after adjudication by the primary insurance carrier, by a transaction processing entity/system that maintains accounts for consumers. Secondary medical claims are submitted through a partner/clearinghouse of the transaction processing entity. The partner/clearinghouse sends notification to the patient and pays amounts from a consumer payment account absent objection from the consumer.

### CROSS REFERENCES TO RELATED APPLICATIONS

This application claims the benefit of and is a non-provisional of U.S. Provisional Application Ser. No. 61/823,968 filed on May 16, 2013, which is hereby expressly incorporated by reference in its entirety for all purposes as if fully set forth herein.

### BACKGROUND OF THE INVENTION

Changes are occurring in the healthcare system in order to control costs. One such change has been the increasing use of “consumer-driven” healthcare insurance policies or plans. These plans often feature a high annual deductible (e.g., $5,000), coupled with a medical savings account (MSA), health savings account (HSA), health reimbursement account (HRA) or other consumer or employer funded financial accounts. The consumer contributes to the account (usually pre-tax) and may be able to accumulate funds over time in which to pay for medical costs not covered by the high deductible insurance policy.

Consumer-driven programs may result in financial/accounting difficulties for some providers. It may be difficult for the consumer and for the provider to keep track of an annual deductible and how an individual charge may be allocated between an insurance company (or other third party payer) and a consumer/patient. At the time of rendering the service, a provider usually has no data available for indicating whether or not a deductible has been met, and such data is typically obtained by submitting a claim to the consumer's insurance company. Further, an important feature of most healthcare policies is that the consumer is able to take advantage of a schedule of “authorized” or “permitted” charges for specific services (usually identified by treatment codes) that are governed by an agreement negotiated between the provider and the insurer. Unfortunately, most providers have contracts with multiple insurance companies, health maintenance organizations (HMOs), or other healthcare payers, and the discounts (and ultimate charges to be paid) for the same services are not the same, but rather will vary from patient to patient (depending on the insurance program that covers the patient). Many providers are unable to confirm the permitted charge until after a claim is submitted and adjudicated by the insurance company.

It can therefore be long after a healthcare service is provided that a charge becomes payable by the consumer. The provider will first submit a claim to the consumer's insurer, and wait for a claim adjudication—usually in the form of an “Explanation of Benefits” (EOB) statement to the consumer from the insurer (a similar statement usually sent at the same time to the provider is often referred to as an “Explanation of Payment” or “EOP”). The EOB will show the permitted charge for the services, and in those cases where the deductible has not been met, confirm that the permitted charge is the patient's responsibility. While the EOB will provide confirmation of what is to be paid by the consumer, it will often take weeks (sometimes months) for the EOB to issue and for the provider to thereafter bill for the permitted charge and to then receive payment from the consumer. In cases where a provider has many patients with “high deductible” plans, a provider may have substantial outstanding charges that are awaiting a determination of the permitted amount and a determination of the paying party (insurance company or consumer). For an individual provider, the delay in receiving such payments can be a significant financial burden. With the delay in billing to the consumer, it can often be difficult for providers to collect amounts owed by consumers. Providers ultimately end up writing off a significant percentage of the amounts owed by consumers that are not covered by health plans.

Further, when a patient portion of a healthcare charge (e.g., an amount not paid by high deductible health care plan) is to be submitted for payment by a financial account (such as an HSA), a financial transaction card (typically a branded debit card, such as a VISA debit card, MasterCard debit card, Discover debit card, etc.) may be presented by the consumer to the healthcare provider to process a payment from the financial account (e.g., to hold for use after a claim is adjudicated and a patient portion has been determined). However, it can be disadvantageous for the healthcare provider to maintain the account/card number for the financial account while it waits adjudication of the primary claim. For example, various card industry requirements (such as the PCI Data Security Standard published by the PCI Security Standards Council) require specific steps be taken by a vendor or other person holding debit/credit card information of a consumer, in order to avoid theft or misuse of that information. Many healthcare providers have neither the desire nor the resources to undertake such steps.

For tax-advantaged accounts, it is often necessary to substantiate amounts that have been paid (i.e., verify that an amount paid from an account was pursuant to a claim that was in fact eligible for payment). There has arisen the need for substantiating payments, particularly efficiently matching payments from tax-advantaged accounts to claims from providers.

### BRIEF SUMMARY OF THE INVENTION

There is provided, in accordance with embodiments of the present invention, a network/system and method for automatic processing of secondary medical claims.

In one embodiment, a method is provided for making payment on a charge from a provider of healthcare services, wherein the services are subject to a healthcare plan administered by a payer, and wherein a patient portion of the charge is not covered by the healthcare plan. The method includes establishing, at a card transaction processing system, a patient account (e.g., funded by an employer or the consumer/patient) for paying the patient portion, wherein the patient authorizes, at the time of establishing, payment to be made from the patient account for paying the patient portion. The method further includes providing a healthcare provider system at a provider location for healthcare services, the provider system for receiving information relating to the patient, including identification for the healthcare plan and the patient, and electronically submitting a claim from the provider system to a first payer system. Further, the method includes adjudicating the claim at the first payer system in order to determine an amount to be paid by the first payer and the amount of the patient portion (after adjudicating the claim), returning data to the provider system that indicates the amount of the patient portion, electronically submitting a claim to a secondary payer system from the provider system for automatic payment of the amount of the patient portion from the patient account, without requiring separate authorization from the patient for the amount of the patient portion. The claim to the second payer system identifies the patient but not the patient account (using a member ID rather than an account number). The second payer system initiates automatic payment the patient portion amount from the patient account to the provider.

A more complete understanding of the present invention may be derived by referring to the detailed description of the invention and to the claims, when considered in connection with the Figures.

### BRIEF DESCRIPTION OF THE DRAWINGS

FIG. 1 is a general block diagram of a payment network for processing and paying medical claims in accordance with one embodiment of the invention.

FIG. 2 is a general block diagram showing a general process for payment of a medical claim in accordance with one embodiment of the invention.

FIG. 3 illustrates a process for a enrolling an employee in a program for payment of a medical claim from a secondary payment account.

FIG. 4 is a flow diagram illustrating the processing and payment of a medical claim from a secondary payment account.

FIG. 5 is a block diagram illustrating an exemplary system upon which embodiments of the present invention may be implemented.

### DETAILED DESCRIPTION OF THE INVENTION

There are various embodiments and configurations for implementing the present invention. Generally, embodiments provide systems and methods for automatically paying secondary medical claims, e.g., after adjudication of claims by a primary insurance or healthcare plan.

In one described embodiment, an employee (or other consumer of medical services) enrolls in a program for payment of secondary medical claims from an account established through a third party administrator that administers benefits plans, for example, on behalf of an employer. At enrollment, an account (such as a health savings account—HSA) is established at a card transaction processing system and from which payments are made to a healthcare provider for amounts (a patient responsibility portion) not covered by a primary insurance or health plan. Payments are made automatically from the account after a claim is adjudicated by a primary insurance entity. The provider is given a member ID to file claims for payment for the amount, rather than an account number. As a further feature in an alternative embodiment, the employee (consumer/patient) may be notified electronically when an amount is paid out of the account, so that prior to automatic payment the employee may notify the card transaction processing entity (or other payment processing entity) if there is an objection or dispute. It should be appreciated that described embodiments of the invention provide, among other things, quicker payment of medical charges owed by a consumer to a medical provider and convenient payment by the consumer to the medical provider, without the provider having to receive sensitive card/account information.

The term “provider” is intended to encompass any person or entity that provides a health-related service to a patient or consumer, including a physician (or other healthcare professional), clinic, hospital, treatment center, dental office, eye/vision center, medical testing laboratory, pharmacy, dispensary, health-related store, and the like. While the term “service” is often used herein, it should be understood that such term is meant to include not only medical and other health-related services, but also physical products and supplies, such as pharmaceuticals, over the counter drugs, devices, equipment and other healthcare products that may be provided during treatment or otherwise purchased by the consumer for health or medical purposes. The term “claim” is intended to encompass not only a request made to an insurance company (as a claim for payment under insurance benefits), but also any request for payment or reimbursement, including payment of a medical charge from an account funded by a patient, an employer, or any other party.

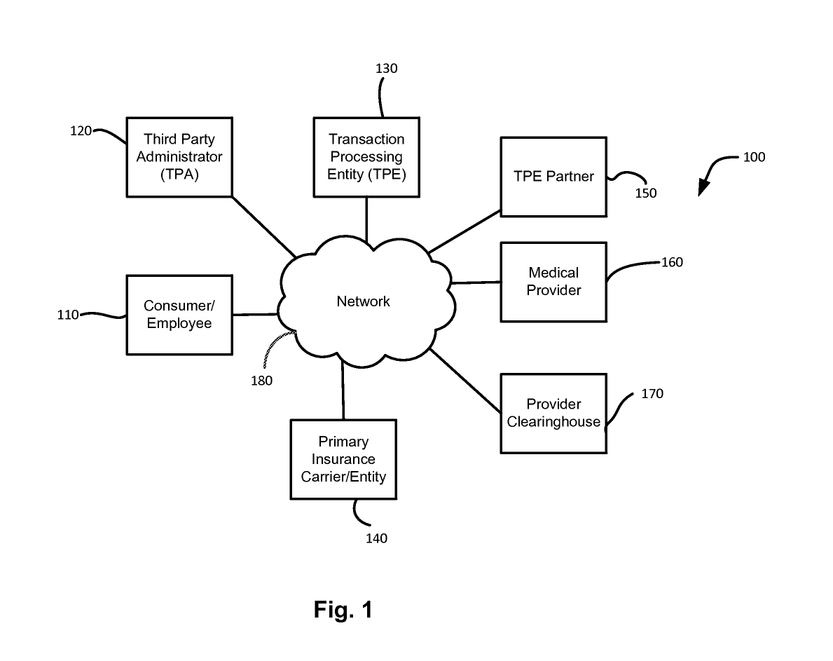

Referring now to FIG. 1, a payment network 100 according to one embodiment of the invention is illustrated. The network 100 illustrates systems used by various parties involved in a medical claims process, including a consumer/employee 110, a third party administrator (TPA) 120 which administers healthcare/benefits plans (e.g., on behalf of an employer of the consumer 110), a card transaction processing entity (TPE) 130 that manages accounts set up through the third party administrator for the consumer and for purposes of paying amounts not paid by a primary healthcare insurance carrier/entity 140, a TPE partner 150 (a partner of or other entity separate from, but working with, the transaction processing entity 130) that acts as a clearinghouse/intermediary and co-ordinates, validates and initiates payments/authorizations to the transaction processing entity 130 in response to secondary payment requests/claims, a medical provider 160 (hospital, physician or other provider of medical related services or products, e.g., to the consumer 110), and a provider clearinghouse 170 through which the medical provider submits medical claims to both the primary insurance entity 140 or other healthcare payers and to the transaction processing entity 130 (through the TPE partner 150). As is common practice, the clearinghouse 170 permits the provider to submit claims to (and receive back claim payment information from) any number of insurance entities 140 (which entities may each have different claims formats and procedures) through interfaces and systems maintained at the clearinghouse 170, and thus eliminating the burden to the provider of having to understand and use different claim formats/procedures required by multiple insurance entities. The various systems of the illustrated parties are all connected to and communicate through a network 180, which may represent a plurality of networks, including the Internet.

Various methods are implemented in the network 100, which will be illustrated and described in greater detail later. Briefly, in one embodiment, the consumer 110 may enroll in a benefits programs of an employer through the third party administrator 120 (e.g., using a website accessed at an employee's personal computer or similar device). One of the benefits programs may permit establishing and funding (e.g., through payroll deductions) a financial payment account (e.g., a tax-advantaged account, such as a health savings account—HSA) for paying any medical charges that are not paid in full by the primary insurance entity 140. The consumer 110 visits the medical provider 160 and provides identification (e.g., cards) for both the insurance plan administered by the insurance entity 140 and the payment account managed by the transaction processing entity 130. As customary, each card includes at least a payer ID and a member ID. The payer ID identifies the primary payer/insurance company 140 in the case of the consumer's primary insurance card and identifies the TPE partner 150 in the case of the card for the consumer's HSA plan. As one example, the payer ID may be a Health Plan Identifier (HPID) or an Other Entity Identifier (OEID) as established under rules promulgated by the United States Department of Health and Human Services (see 45 CFR Part 162, published in the Federal Register on Sep. 5, 2012 at 77 FR 54719). The member ID is a unique identifier used by the insurance company and by the TPE partner 150 to identify the consumer. In some cases the member ID may have a format unique to each payer and in other cases it may be an identifier that can be used in common by multiple payers (e.g., a social security number).

The provider 160 may submit a primary medical claim through its clearinghouse 170 to the primary insurance entity 140. After adjudication of the primary medical claim, and if the claim is not paid in full, the insurance entity 140 informs the medical provider 160 (through the provider clearinghouse 170) of any uncovered amount that is the patient's responsibility. The medical provider then submits a secondary claim for payment (against the financial payment account rather than against the primary insurance plan of the consumer/patient) through its clearinghouse 170 to the TPE partner 150, which acts a clearinghouse for secondary medical claims processing for the transaction processing entity 130. The TPE partner 150 validates the secondary claim, and provides the proper payment amount to the transaction processing entity 130. If the claim is validated and sufficient funds are held in the financial account maintained by the transaction processing entity 130, a payment is processed by the transaction processing entity 130 (similar to a debit or credit “card not present transaction”), and such payment is credited to the medical provider 160.

While FIG. 1 illustrates various parties and their systems used in processing a medical claim in accordance with embodiments of the invention, it should be appreciated that, in alternative embodiments, additional parties or fewer parties than those illustrated might be involved.

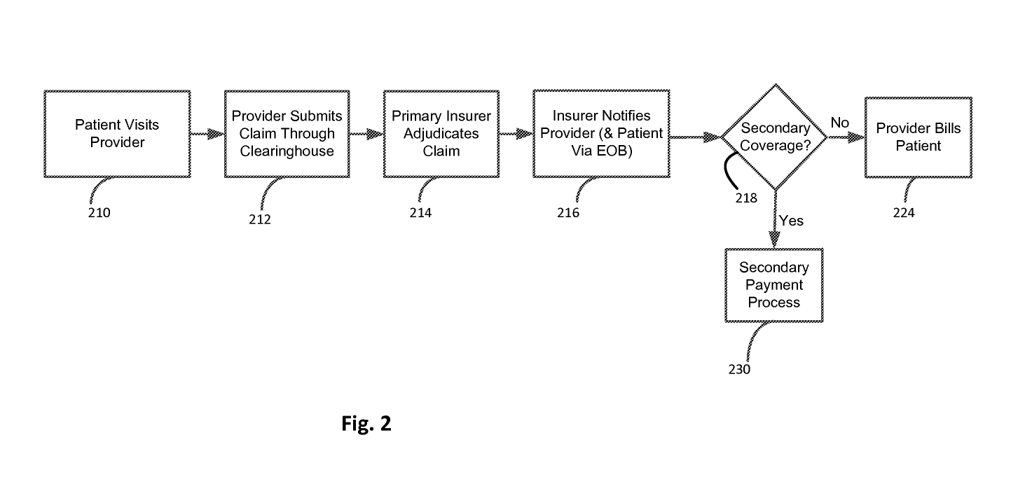

Turning now the FIG. 2, there is illustrated a general process for processing a medical claim in accordance with one embodiment of the invention. As seen, at step 210 a patient visits a provider (e.g., a physician's office) for services. In one example, it is assumed that the patient may present two ID cards to the provider: (1) a primary insurance card having at least a payer ID (the payer ID for the consumer's primary insurance company 140) and an individual consumer/member ID identifying the consumer to the insurance company, and (2) a secondary payment plan ID card having the secondary payer ID (in this embodiment, the payer ID for the TPE partner 150 as the entity processing secondary requests/claims) and an individual consumer/member ID identifying the consumer to the TPE partner. After the services are provided, the provider submits a claim (through the provider's clearinghouse) to the primary insurance entity for the patient at step 212. The primary insurance entity adjudicates the claim at step 214, and (after adjudication) notifies the provider (step 216) through the provider's clearinghouse (as well as notifying the patient via an explanation of benefits (EOB) statement) of the amounts that will be paid under the patient's insurance, and the amount (if any) that will be the responsibility of the patient.

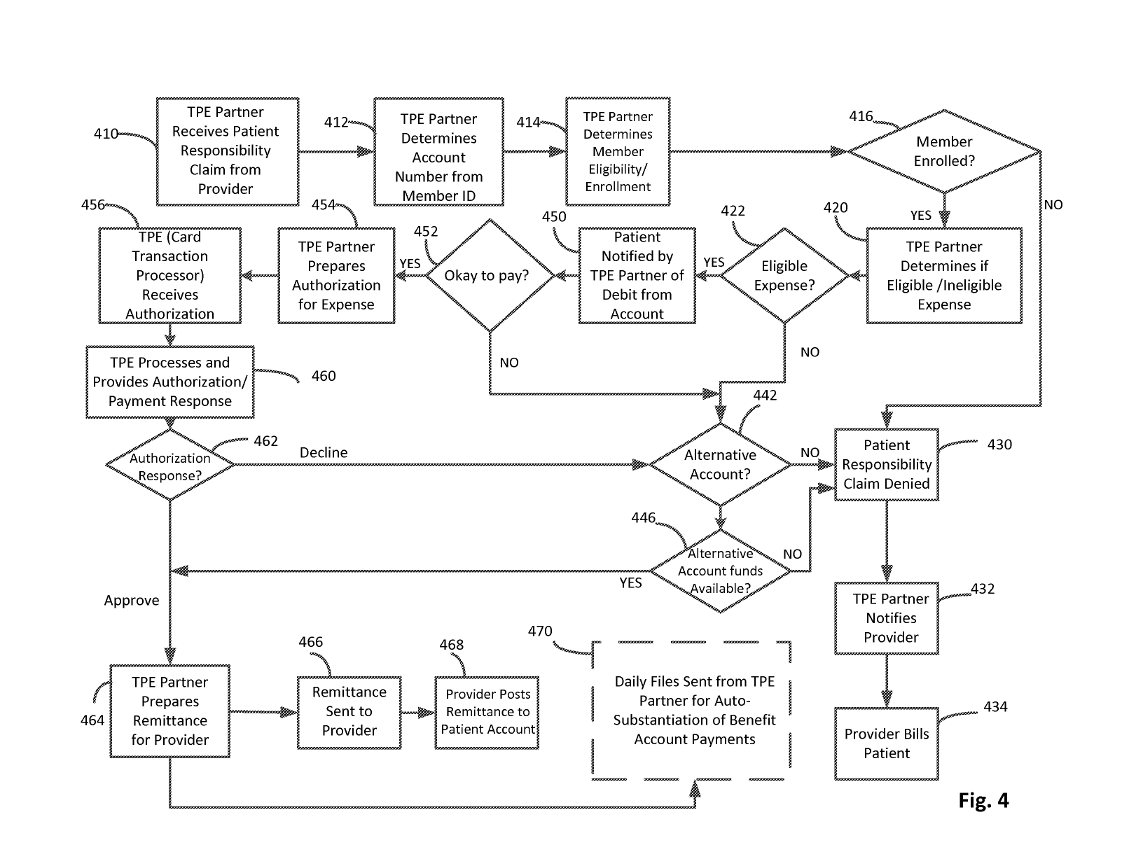

The provider determines if the patient has secondary coverage at step 218. Typically, this would be determined based on whether the patient has provided a card for secondary coverage (as described earlier), and if not, the provider bills the patient for the amount owed by the patient at step 224. If the patient does have secondary coverage, the provider initiates a process for secondary claim processing/payment at step 230, which will be described later in conjunction with FIG. 4.

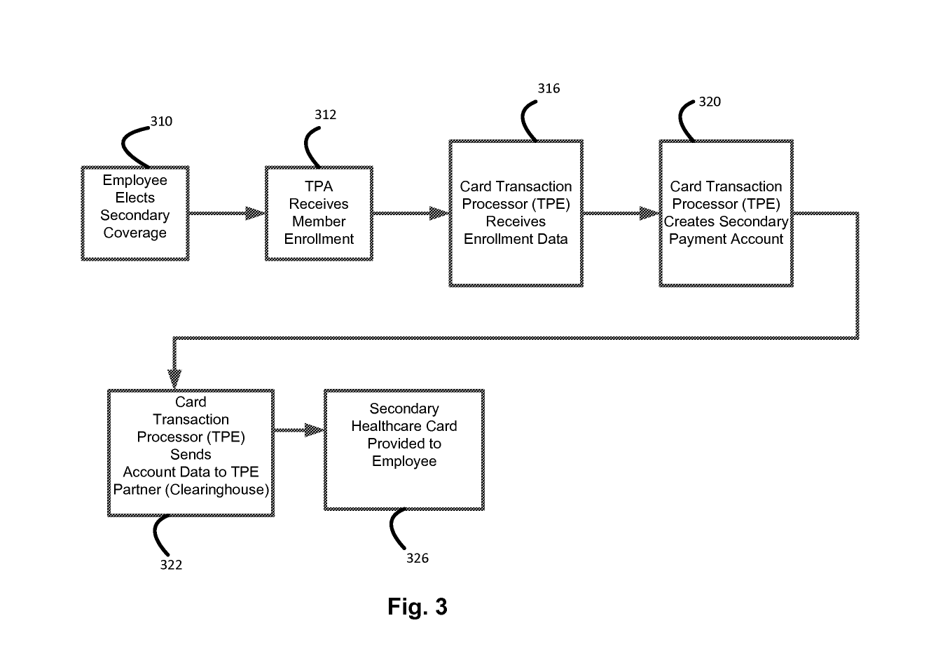

FIG. 3 illustrates a process for an employee to enroll in a program for establishing a payment account at the transaction processing entity 130 and for paying secondary medical claims out of that account. At step 310, the employee elects automatic payment of patient responsibility amounts that is implemented by setting up an account managed by the card transaction processing entity 130. In in the described embodiment, the account set up during enrollment is an HSA account designed for use in conjunction with a high deductible health care insurance plan. However other financial accounts may be used in accordance with other embodiments, such as a medical savings account (MSA), a flexible spending account (FSA), a healthcare reimbursement account (HRA), and other types of tax-advantaged accounts regulated by the Internal Revenue Service (IRS) and funded by the employee or employer. Also, it should be understood that the embodiments of the invention may be used in conjunction with insurance other than high deductible insurance plans. In some cases, the employee may also provide an additional personal account (e.g., a checking account, credit card account or debit card account) that may be used for paying some or all of a patient portion when a payment (or a full payment) cannot be made out of the HSA account.

The election at step 310 may be made at a website operated by the third party administrator 120 on behalf of an employer of the consumer/employee. The third party administrator receives data entered by the employee during member enrollment at step 312, and transmits that information to the transaction processing entity 130 at step 316. In response, the transaction processing entity creates, at step 320, a secondary payment account (having an associated account/card number, member ID and other personal data for the employee) and sends account and personal data to the TPE partner at step 322, to be used in processing secondary medical claims. As mentioned earlier, the TPE partner acts as a clearinghouse for the transaction processing entity 130 for purposes of receiving secondary payment claims from providers (usually through the clearinghouse 170 of the provider). Finally, at step 326, a secondary payment card associated with the HSA account is provided by the third party administrator to the employee, with the card showing plan information, such as a payer ID for the TPE partner 150 and the member ID for the employee.

The following Table I illustrates an exemplary file sent from the TPE 132 to the TPE partner 150 (step 322) in response to enrollment and establishment of an HSA account for an employee/member:

TABLE I

Member ID
Member Last Name
Member First Name
Member Middle Name
Gender
BirthDate
Member Address 1
Member Address 2
Member City
Member State
Member Zip1
Member Zip2
Terminate Member
Begin Effective Date
End Effective Date
EmailAddress
Member Phone Number
Member Card Number
Card Expiration Date

The file for each member provided to the TPE partner 150 is stored by the TPE partner at its system for access when a claim for secondary healthcare coverage is submitted to the TPE partner. Further, as should be apparent, the information in the file for each member may be periodically updated as needed, such as in response to updating data being provided through the third party administrator 120 from the employee/member.

The member ID associated with an employee/consumer is given to a provider (along with other plan information on the secondary healthcare plan card) and is particularly advantageous to the provider (rather than directly receiving an HSA account/card number from the consumer). As mentioned earlier, such member ID is included on the card presented by the member, and permits the provider to submit a claim (through its clearinghouse) without having knowledge or access to the actual account/card number associated with the financial account (e.g., HSA). By having the card number concealed from the provider, the provider is not burdened with maintaining financial account information and having to take precautions for its safekeeping, as would be required if the account/card number itself were given to the provider. When the account/card number is needed for processing a transaction against the HSA, it is accessed by the TPE partner by using the file for the member stored at the TPE partner (e.g., as illustrated in Table I above).

While not illustrated in FIG. 3, it should be appreciated that the consumer/patient could provide an alternative payment account to pay for a patient portion of a medical charge, e.g., if there are not sufficient funds in the payment account (established at the transaction processing entity) or if the expense is not eligible for reimbursement. For example, during the enrollment process seen in FIG. 3, the third party administrator could receive, in addition to other enrollment data at step 312, an existing personal checking/credit/debit card account number from the employee as an alternative for paying the patient portion (e.g., should there be insufficient funds in the payment account set up at step 320). As will be described shortly in connection with a secondary payment process seen in FIG. 4, if there are insufficient funds in the secondary payment account (or an expense is not eligible for reimbursement under a tax-advantaged account, such as an HSA), the TPE partner 150 could authorize a payment from such alternative personal account. Further, it should be appreciated that in some cases, as part of enrollment, a consumer may elect to have eligible expenses be taken out of the alternative personal account, even if funds are available in the tax-advantaged account (HSA).

FIG. 4 illustrates steps for processing and paying secondary claims (implementing the process illustrated at step 230 in FIG. 2) against a tax-advantaged financial account (e.g., an HSA account). The TPE partner 150 receives (through the provider clearinghouse 170) the secondary claim at step 410 having the patient responsibility amount (secondary claim amount) for which the provider is seeking payment. In response, at step 412, the TPE partner determines from the member ID (included in the secondary claim as originally prepared by the provider) the account/card number associated with the tax-advantaged financial account (HSA), step 412 (e.g., by using or doing a look-up at the file associated with the member illustrated in Table I above). The TPE partner, at steps 414 and 416, determines whether the patient/member is eligible/enrolled for secondary payment (e.g., confirms that the member ID and patient name correspond to a current enrollee). It should be appreciated that the provider may also need to be eligible (enrolled with the TPE partner) in order for the TPE partner to be authorized to post credits to the provider account if a secondary claim payment is approved, and thus the eligibility of the provider may also be determined at steps 414 and 416.

If the member is determined not to be eligible at steps 414 and 416, then the patient responsibility claim (secondary claim for the amount not paid by the primary insurance) is denied at step 430, and the TPE partner notifies the provider of the denial at step 432. The provider in turn bills the patient for the patient portion, step 434. If the member is determined to be eligible at steps 414 and 416, then the TPE partner next determines whether the specific expense (the nature of the service or product for which reimbursement is sought, as may be indicated by a treatment or product code submitted with the claim by the provider) is eligible for payment from the tax-advantaged payment account, steps 420 and 422. If the expense is not eligible, the TPE partner determines if an alternative personal account was provided by the patient as part of enrollment at step 442, and if it was provided and has funds available (step 446), the TPE partner processes a payment against that personal account. If an alternative account was not provided (step 442), then the claim is denied at step 430 (and the TPE partner notifies the provider and the provider bills the patient, steps 432 and 434).

If the expense is found to be eligible at step 422, the TPE partner notifies the patient of the amount to be debited from the account of the patient at step 450. For example, the notification may be in the form of an email, text or other electronic communication to the patient, giving the patient the option to approve the payment (e.g., within a specified period of time, such as via return/reply email). If the patient does not approve (step 452), the TPE partner again determines if the patient has provided an alternative personal account at step 442. If there is an alternative account, and that account has funds available at step 446, the amount is processed against the alternative account. If there is no alternative account (or it has insufficient funds), the claim is denied at step 430. It should be understood that in some embodiments, the patient may also be asked to approve a debit against the alternative account as part of the approval by the patient at step 452, and if the patient does not approve use of an alternative account for the particular expense, the claim is likewise denied. Thus, if the patient objects to the amount of the charge (and does not want it debited against either the tax-advantaged account or the alternative account), after denial of the claim at step 430, the proper amount to be paid to the provider may need to be resolved between the patient and the provider, and once resolved, the provider may resubmit the claim.

If the debit from the account is approved by the patient at step 452, then the TPE partner prepares an authorization for the expense at step 454, and provides the authorization to the transaction processing entity (TPE) 130 at step 456. The transaction processing entity processes the authorization and provides an authorization/payment response (steps 460, 462), based on the balance in the tax-advantaged account. If the authorization response indicates that there is an insufficient balance in the account to pay the claim and declines/rejects the payment (step 462), then the TPE partner determines whether an alternative account was provided by the patient (step 442) and if there is such an alternative account, the amount of the claim is processed against the alternative account if it has funds available to pay the claim, step 446. As an example, if the alternative account is a credit card account, and the amount of the claim would not cause the card balance to exceed the credit limit of the account, the claim would paid from the credit card account at step 446.

If there are sufficient funds available from tax-advantaged account and the transaction is approved at step 462, or if there has been a denial but funds are available from the alternative account to pay the claim at step 446, then the TPE partner prepares a remittance for the provider at step 464, and such remittance is sent by the TPE partner to the provider (e.g., by ACH credit to the provider's bank account) at step 466. At step 468, the provider posts the remittance to the patient's account at the provider, to reflect payment on the secondary claim.

It should be appreciated that in some cases the authorization response may be a partial decline (or partial approval) at step 462, in which case part of the claim amount may be processed and paid by the transaction processing entity out of the tax-advantaged account (at steps 460 and 462) and another part of the claim amount may be submitted for payment from the alternative account (at steps 442 and 446).

While not necessarily part of the claim adjudication and payment process, an additional step 470 is illustrated in FIG. 4. In such step, files reflecting all claims processed by the TPE partner 150 may be sent daily to the transaction processing entity 130 for purposes of auto-substantiation. Such step permits better compliance with IRS requirements (as may be required for certain tax-advantaged accounts, such as FSA and HRA accounts), by showing a relationship between a claim processed by the TPE partner 150 and an actual payment made by the transaction processing entity 130 against the tax-advantaged account. For example, if the transaction processing entity 130 matches a claim sent by the TPE partner at step 466 to a payment processed and approved by the transaction processing entity at steps 460 and 462, such payment may automatically be deemed substantiated (“auto-substantiation”) under current IRS regulations. In addition, and while not shown in FIG. 4, the transaction processing entity 130 might also use approval by the TPE partner of treatment codes and other identifiers in the secondary claim (step 422) as reflected in the daily files to confirm that the payments made from the account are in fact specifically eligible for payment under current IRS regulations.

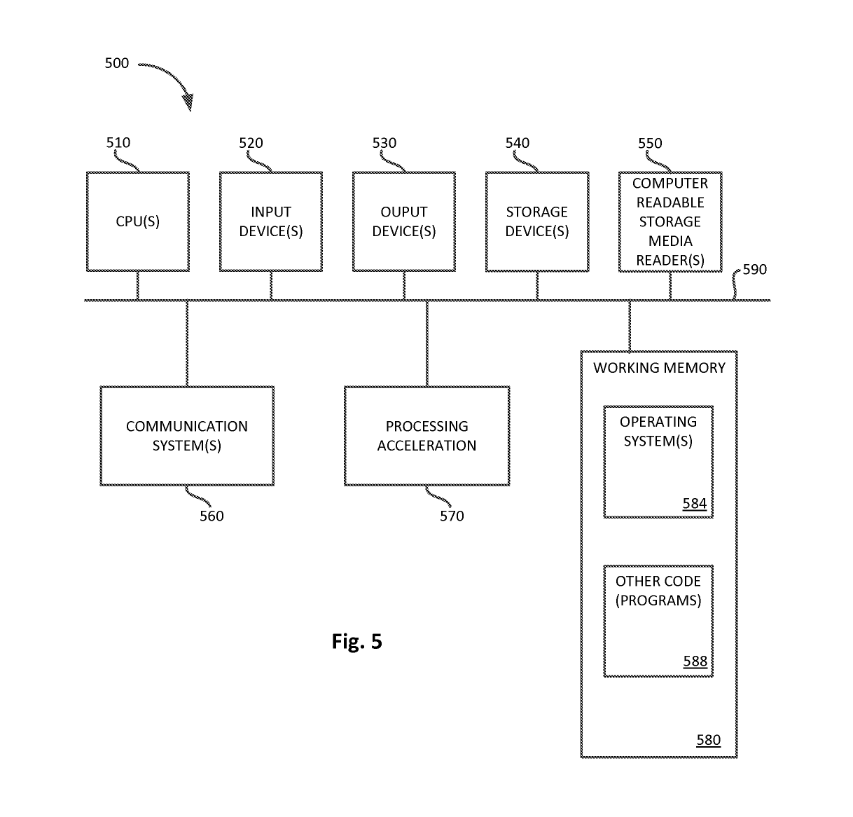

FIG. 5 is a block diagram illustrating an exemplary computer system upon which embodiments of the present invention may be implemented. This example illustrates a computer system 500 such as may be used, in whole, in part, or with various modifications, to provide the functions of the systems at the third party administrator (TPA) 120, the transaction processing entity (TPE), TPE partner 150, medical provider 160 or provider clearinghouse 170, as well as other components and functions of the invention described herein.

The computer system 500 is shown comprising hardware elements that may be electrically coupled via a bus 590. The hardware elements may include one or more central processing units 510, one or more input devices 520 (e.g., a mouse, a keyboard, etc.), and one or more output devices 530 (e.g., a display device, a printer, etc.). The computer system 500 may also include one or more storage devices 540, representing remote, local, fixed, and/or removable storage devices and storage media for temporarily and/or more permanently containing computer-readable information, and one or more storage media reader(s) 550 for accessing the storage device(s) 540. By way of example, storage device(s) 540 may be disk drives, optical storage devices, solid-state storage devices such as a random access memory (“RAM”) and/or a read-only memory (“ROM”), which can be programmable, flash-updateable or the like.

The computer system 500 may additionally include a communications system 560 (e.g., a modem, a network card—wireless or wired, an infra-red communication device, a Bluetooth™ device, a near field communications (NFC) device, a cellular communication device, etc.). The communications system 560 may permit data to be exchanged with a network, system, computer, mobile device and/or other component as described earlier. The system 500 also includes working memory 580, which may include RAM and ROM devices as described above. In some embodiments, the computer system 500 may also include a processing acceleration unit 570, which can include a digital signal processor, a special-purpose processor and/or the like.

The computer system 500 may also comprise software elements, shown as being located within a working memory 580, including an operating system 584 and/or other code 588. Software code 588 may be used for implementing functions of various elements of the architecture as described herein. For example, software stored on and/or executed by a computer system, such as system 500, can be used in implementing the processes seen in FIGS. 2, 3 and 4.

It should be appreciated that alternative embodiments of a computer system 500 may have numerous variations from that described above. For example, customized hardware might also be used and/or particular elements might be implemented in hardware, software (including portable software, such as applets), or both. Furthermore, there may be connection to other computing devices such as network input/output and data acquisition devices (not shown).

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention. As one example, the various systems 120-170 110 may each be implemented by a single system having one or more storage device and processing elements. As another example, the same systems may each be implemented by plural systems, with their respective functions distributed across different systems either in one location or across a plurality of linked locations.

Moreover, while the various flows and processes described herein (e.g., those illustrated in FIGS. 2, 3 and 4) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method for paying a charge from a provider of healthcare services, wherein the services are subject to a healthcare plan administered by a payer, and wherein a patient portion of the charge may not be covered by the healthcare plan, the method comprising:
establishing, at a card transaction processing system, a patient financial account funded for paying the patient portion, wherein the patient authorizes, at the time of establishing the patient financial account, payment to be made from the patient financial account for paying the patient portion;
receiving, at a healthcare provider system, information relating to the patient, including identification for the healthcare plan and the patient;
electronically submitting a first claim from the provider system to a first payer system;
adjudicating the first claim at the first payer system in order to determine an amount to be paid by the first payer and the amount of the patient portion;
after adjudicating the first claim, returning data to the provider system that indicates the amount of the patient portion;
electronically submitting a second claim from the provider system to a second payer system, for automatic payment of the amount of the patient portion from the patient financial account, wherein the second claim identifies the patient but not the financial patient account; and
paying at least some of the amount of the patient portion from the patient financial account to the provider.

2. The method of claim 1, further comprising:
enrolling the patient in order to establish the patient financial account, wherein the enrollment includes receiving personal information from the patient in order to establish the patient financial account, and wherein the enrollment further includes receiving, from the patient, account information relating to an alternative personal account of the patient that is separate from the patient financial account;
determining whether the full amount of the patient portion is to be paid from funds in the patient financial account; and
if the full amount of the patient portion is not to be paid from funds in the patient financial account, paying at least some of the patient portion from the alternative personal account of the patient.

3. The method of claim 2, wherein determining whether the full amount of the patient portion is to be paid comprises:
determining if the patient financial account has funds available for paying the full amount of the patient portion; and
paying some or all of the patient portion from the alternative personal account if the patient financial account does not have funds available for paying the full amount of the patient portion.

4. The method of claim 2, wherein the alternative personal account of the patient is selected from a group comprising a checking account, debit card account and a credit card account of the patient.

5. The method of claim 1, further comprising:
prior to paying at least some of the amount of the patient portion from the patient financial account, notifying the patient of the amount of the patient portion to be paid from the patient financial account; and
determining whether the patient objects to the patient portion being paid from the patient financial account.

6. The method of claim 1, wherein the patient financial account is a tax-advantage account.

7. The method of claim 6, wherein the tax-advantaged account is a health savings account (HSA) regulated by the Internal Revenue Service.

8. The method of claim 1, wherein paying at least some of the amount of the patient portion from the patient financial account to the provider is performed automatically unless the patient objects to paying the amount of the patient portion from the patient financial account.

9. The method of claim 1, wherein the second payer system is operated by an entity that is separate from the entity operating the transaction processing system.

10. The method of claim 1, wherein establishing a patient financial account includes issuing a member ID for the patient, the member ID identifying the patient and the patient financial account, wherein the second claim includes the member ID, and wherein the second payer system identifies the financial patient account based on the member ID.

11. The method of claim 10, wherein the second payer system is operated by an entity that is separate from the entity operating the transaction processing system, wherein, after establishing the patient financial account at the card transaction processing system, the card transaction processing system transmits the member ID for the patient to the second payer system, wherein the entity operating the second payer system stores a file associating the member ID with an identifier for the financial patient account, and wherein the second payer system identifies the financial patient account by accessing the file associating the member ID with an identifier for the financial patient account.

12. The method of claim 1, wherein the patient is an employee of an employer, wherein the employer, through a third party administrator, enrolls the employee in a plan for establishing the financial patient account, and wherein the third party administrator provides personal data of the employee to the transaction processing system to be associated with the established financial patient account.

13. The method of claim 12, wherein the employer contributes funds to the financial patient account.

14. The method of claim 1, wherein the second payer system periodically provides claim files to the card transaction processing system, the claim files including information on claims approved by the second payer system, and wherein the card transaction processing system uses the claim files to substantiate transactions against the patient financial account by comparing transactions against the patient financial account to information on claims in the claim files.

15. A method paying a charge from a provider of healthcare services to a consumer, wherein the services are subject to reimbursement under a first healthcare plan administered by a first payer, and for any patient portion of the charge not reimbursed by the first healthcare plan, under a second healthcare plan administered by a second payer, wherein the second healthcare plan includes at least a financial account maintained for the consumer, the financial account having an account number used to process transactions against the financial account through a transaction processing system, the method comprising:
enrolling the consumer in the first healthcare plan, including assigning a first payer ID that identifies an entity administering the first healthcare plan and a first member ID that identifies the consumer to the first payer;
enrolling the consumer in the second healthcare plan, including assigning a second payer ID that identifies the entity administering the second healthcare plan, and a second member ID that identifies the consumer to the second payer but that does not identify the account number of the financial account;
in response to enrollment in the second healthcare plan, establishing, at the transaction processing system, a financial account funded for paying the patient portion, wherein the financial account is identified by an account number used to process transactions by the transaction processing system against the financial account, and wherein the patient authorizes, at the time of enrollment, payment to be made from the financial account for paying the patient portion;
providing, to a healthcare provider system at a provider location, the first payer ID, the first member ID, the second payer ID and the first member ID, for use in submitting healthcare claims, wherein none of the first payer ID, the first member ID, the second payer ID and the second member ID provide identification of the financial account;
electronically submitting a first claim from the provider system to a first payer system, using the first payer ID and first member ID;
adjudicating the first claim at the first payer system in order to determine an amount to be paid by the first payer and the amount of the patient portion;
after adjudicating the first claim, returning data to the provider system that indicates the amount of the patient portion;
electronically submitting a second claim from the provider system to a second payer system using the second payer ID and second member ID; and
if sufficient funds are in the financial account, automatically paying the amount of the patient portion from the financial account to the provider.

16. The method of claim 15, wherein the financial account is a tax-advantage account.

17. The method of claim 16, wherein the tax-advantaged account is a health savings account (HSA) regulated by the Internal Revenue Service.

18. The method of claim 15, wherein paying the amount of the patient portion from the financial account to the provider is performed automatically unless the patient objects to paying the amount of the patient portion from the financial account.

19. The method of claim 15, wherein the second payer system is operated by an entity that is separate from the entity operating the transaction processing system.

20. The method of claim 15, wherein the second payer system determines the account number for the financial account based on the member ID.

21. A method for processing a charge for healthcare services, comprising:
at a healthcare provider system, receiving plan information provided by a consumer for at least two different healthcare plans, wherein the healthcare plans include:
a first healthcare plan that provides primary coverage for healthcare services received by the consumer from a healthcare provider, wherein the received plan information for the first plan includes at least information that identifies both a first entity administering the first healthcare plan and the consumer; and
a second healthcare plan that provides secondary coverage for healthcare services received by the consumer from the healthcare provider, the second plan including at least a financial account maintained for the consumer and designated by the consumer to pay charges for healthcare services, the financial account having an account number that is used to process, by a transaction processing system, a transaction against the financial account, the plan information for the second plan includes at least information that identifies both an entity administering claims for the second healthcare plan and the consumer, wherein the plan information for the second plan provided to the provider does not reveal the account number to the provider;
electronically submitting a first claim, including the plan information for the first plan, from the provider system to a first payer system;
adjudicating the first claim at the first payer system in order to determine an amount of the healthcare charge paid by the first payer and an patient portion of the healthcare charge not paid by the first plan; and
after adjudication of the first claim at the first payer system, electronically submitting a second claim, including the plan information for the second plan, from the provider system to the second payer system, wherein the second payer system uses at least the portion of the plan information for the second plan identifying the consumer in order to determine the account number, and then uses the determined account number to process a transaction against the financial account at the transaction processing system.
